(19) United States
(12) Patent Application Publication
(10) Pub. No.: US 2026/0232509 A1
(43) Pub. Date: Aug. 13, 2026

(54) LIMB SUPPORT TOOL

(71) Applicant: MIZUHO Corporation, Tokyo (JP)

(72) Inventors: Kazuhiko KAWASE, Niigata (JP); Kazuya HASEGAWA, Niigata (JP); Naoto ISHIZAKA, Niigata (JP)

(21) Appl. No.: 19/168,141

(22) PCT Filed: Mar. 4, 2024
(86) PCT No.: PCT/JP2024/008101

§ 371 Date: Sep. 23, 2025

(30) Foreign Application Priority Data
Mar. 30, 2023 (JP) 2023-056006

(51) Int. Cl. A61G 13/12

(52) U.S. Cl. CPC A61G 13/1245; A61G 13/1265

(57) ABSTRACT

Provided is a limb support tool that ensures a desired turning range of an arm member that supports a patient's limb and allows simplifying its structure. In a limb support tool, an upper limit position of an arm member that supports a patient's limb is restricted when a piston rod of a gas cylinder is in a most extended state, while a lower limit position of the arm member is restricted when the piston rod of the gas cylinder is in a most shrunk state. This ensures a desired turning range of the arm member, especially along an up-down direction, and allows simplifying the structure of the limb support tool.

### TECHNICAL FIELD

The present invention relates to a limb support tool that is detachably attached to a surgical table to support a limb, for example, a lower limb.

### BACKGROUND ART

As a conventional limb support tool, Patent Document 1 discloses that at least one of a distal gas piston mounting element and a proximal gas piston mounting element, which constitute a limb support tool, is configured to be movable between at least two positions while a limb holder support structure is moved through its range of motion. The distal gas piston mounting element moves relative to the limb holder support structure, and the proximal gas piston mounting element rotates relative to the limb holder support structure mounting element.

In other conventional limb support tools, the lower limit position of an arm member that supports a patient's limb is restricted by the interference of an end portion in a longitudinal direction of a gas cylinder (an end portion close to a base of the arm member) with a stopper member.

### CITED DOCUMENTS

### Patent Literature

Patent Document 1: U.S. Pat. No. 10,869,801

### DISCLOSURE OF THE INVENTION

### Problems to be Solved by the Invention

However, the limb support tool described in Patent Document 1 employs a configuration in which the distal gas piston mounting element moves relative to the limb holder support structure, and the proximal gas piston mounting element rotates relative to the limb holder support structure fixed to an anchoring bracket relative to a surgical table. Therefore, the structure is complex and has a large number of parts, resulting in a high manufacturing cost, which needs to be improved.

In addition, in other conventional limb support tools, the lower limit position of the arm member is set by the interference of the end portion in the longitudinal direction of the gas cylinder with the stopper member. This also makes the structure complex and increases the number of parts. Further, with this stopper structure, as the number of times used increases, the end portion in the longitudinal direction of the gas cylinder and the stopper member may become damaged, causing inconvenience and decreasing reliability. This point also needs to be improved.

The present invention has been made in consideration of the points, and an object of the present invention is to provide a limb support tool that ensures a desired turning range of an arm member that supports a patient's limb and allows simplifying its structure.

### Solutions to the Problems

As means to solve the above-described problems, there is provided an invention relating to a limb support tool of claim 1. The limb support tool is attached to a surgical table to support a patient's limb and includes an arm member and a gas cylinder. The arm member supports a patient's limb and is supported turnably in any direction centered on a base thereof and in a restrainable manner at any position. The gas cylinder has one end portion in a longitudinal direction turnably coupled to the arm member and is supported turnably in any direction together with the arm member. An upper limit position of the arm member is restricted when a piston rod of the gas cylinder is in a most extended state, while a lower limit position of the arm member is restricted when the piston rod of the gas cylinder is in a most shrunk state.

With the invention of claim 1, the respective upper and lower limit positions of the arm member can be restricted when the piston rod of the gas cylinder is in the most extended and shrunk states, and a desired turning range along an up-down direction can be set. This can simplify the structure, result in a reduction in the number of parts, and eventually reduce the manufacturing cost, compared to the prior art described above. Moreover, since a stopper structure is not employed when the upper and lower limit positions of the arm member are set, there is no need to provide members that interfere with one another, and reliability can be improved. For the upper limit position of the arm member, an upward turning angle relative to a horizontal direction is set to, for example, approximately 80°. Meanwhile, for the lower limit position of the arm member, a downward turning angle relative to the horizontal direction is set to, for example, approximately 35°.

According to an invention relating to a limb support tool of claim 2, in the invention according to claim 1, another end portion in a longitudinal direction of the gas cylinder is turnably supported on a spherical portion disposed to protrude from a surface of a base plate fixed to the surgical table.

With the invention of claim 2, the other end portion in the longitudinal direction of the gas cylinder is turnably supported directly on the spherical portion disposed to protrude from the base plate fixed to the surgical table, thereby eliminating the need for a proximal gas piston mounting element turnably coupled to a limb holder support structure mounting element corresponding to the base plate, as it is needed in the prior art (invention of Patent Document 1) described above. Therefore, from this point as well, the structure can be simplified, and the number of parts can be reduced.

According to an invention relating to a limb support tool of claim 3, in the invention according to claim 2, a turning center at the other end portion in the longitudinal direction of the gas cylinder is positioned below a turning center at the base of the arm member and on a patient's leg side. A straight line connecting the turning center at the other end portion in the longitudinal direction of the gas cylinder and the turning center at the base of the arm member is set with an inclination angle relative to a vertical direction within a range between 15° and 30°.

With the invention of claim 3, the respective upper and lower limit positions of the arm member can be restricted, without complicating the structure, when the piston rod of the gas cylinder is in the most extended and shrunk states, and a desired turning range along an up-down direction can be set.

According to an invention relating to a limb support tool of claim 4, in the invention according to claim 2 or 3, the base plate is disposed upright to be approximately parallel to a front-back direction of the surgical table. The spherical portion is inclined at a predetermined inclination angle to a patient's head side relative to a direction perpendicular to a surface of the base plate.

With the invention of claim 4, the turning range of the gas cylinder to the outer side in a right-left direction of the surgical table along the horizontal direction can be increased.

According to an invention relating to a limb support tool of claim 5, in the invention according to claim 1, the arm member is supported turnably along a horizontal direction relative to a front-back direction of the surgical table, within a range of an identical angle each to an inner side and an outer side of the surgical table centered on a reference line. The reference line is inclined to an outer side in a right-left direction of the surgical table toward a patient's leg.

The turning center at the other end portion in the longitudinal direction of the gas cylinder is slightly different in position from the turning center at the base of the arm member in the front-back direction of the surgical table. Therefore, a difference occurs between a turning trajectory along the horizontal direction relative to the turning center of the arm member at any position in the longitudinal direction of the arm member and a turning trajectory along the horizontal direction relative to the turning center of the gas cylinder at any position in the longitudinal direction of the arm member. In consideration of this, with the invention of claim 5, the arm member is turned along the horizontal direction relative to the front-back direction of the surgical table, within a range of an identical angle, for example, approximately 20°, each to the inner side and the outer side of the surgical table centered on the reference line. The reference line is inclined at a predetermined inclination angle, for example, an inclination angle of approximately 10°, to the outer side in the right-left direction of the surgical table toward the patient's leg. This allows the difference between both turning trajectories described above to be minute within the turning range along the horizontal direction of the arm member, for example, within the turning range of a maximum turning angle of approximately 30° to the outer side in the right-left direction of the surgical table and a maximum turning angle of approximately 10° to the inner side in the right-left direction of the surgical table, relative to the front-back direction of the surgical table.

According to an invention relating to a limb support tool of claim 6, in the invention according to claim 1, one end portion in a longitudinal direction of the gas cylinder is coupled to the arm member via a bracket, and the bracket is formed in an approximate L-shape in side view.

A boot that immobilizes a patient from near the knee to the tip of the foot is slidably supported on the arm member along the longitudinal direction in a range from the position of the bracket to the distal end of the arm member. With the invention of claim 6, the bracket is formed in an approximate L-shape in side view, thereby ensuring a sufficient amount of sliding of the boot.

### Effects of the Invention

The limb support tool according to the present invention ensures a desired turning range of an arm member that supports a patient's limb, especially along an up-down direction, and allows simplifying its structure.

### BRIEF DESCRIPTION OF THE DRAWINGS

FIG. 1 is a perspective view of an entire limb support tool according to the embodiment.

FIG. 2 is a perspective view of the vicinity of a base of an arm member of the limb support tool according to the embodiment viewed from an inner side in a right-left direction of a surgical table.

FIG. 3 is a perspective view of the vicinity of the base of the arm member of the limb support tool according to the embodiment viewed from an outer side in the right-left direction of the surgical table.

FIG. 4 is a perspective view illustrating a state where one end portion in a longitudinal direction of a gas cylinder of the limb support tool according to the embodiment is coupled to the arm member via a bracket.

FIG. 5 is a perspective view illustrating the peripheral structure of an anchoring bracket and a base plate of the limb support tool according to the embodiment.

FIG. 6 is a side view illustrating the positional relationship in side view between a spherical portion of a spherical joint and a spherical portion of a coupling shaft portion, which extend from the base plate of the limb support tool according to the embodiment.

FIG. 7 is a top view illustrating the spherical portion of the spherical joint and the spherical portion, including the coupling shaft portion and a rod portion, which extend from the base plate of the limb support tool according to the embodiment.

FIG. 8 is a perspective view of the vicinity of the base of the arm member of the limb support tool according to the embodiment viewed from the inner side in the right-left direction of the surgical table, which omits the illustration of a cover member.

FIG. 9 is an exploded perspective view of turning restraint means of the limb support tool according to the embodiment.

FIG. 10 is a side view of the turning restraint means of the limb support tool according to the embodiment (including a partial cross section), which omits the illustration of the cover member.

FIG. 11 is a side view illustrating a state where the arm member of the limb support tool according to the embodiment turns along an up-down direction, within a range of an upward maximum turning angle of approximately 80° and a downward maximum turning angle of approximately 35° relative to a horizontal direction.

FIG. 12 is a top view illustrating a state where the arm member of the limb support tool according to the embodiment turns along the horizontal direction relative to a front-back direction of the surgical table within a range of approximately 20° each to an inner side and an outer side of the surgical table, centered on a reference line CL. The reference line CL is inclined at an inclination angle of approximately 10° to the outer side in the right-left direction of the surgical table toward a patient's leg.

FIG. 13 is a diagram illustrating a turning trajectory LO1 along the horizontal direction relative to a turning center of the arm member (a center O1 of the spherical portion of the spherical joint) of the limb support tool according to the embodiment, a turning trajectory LO2 along the horizontal direction relative to a turning center of the gas cylinder (a center O2 of the spherical portion of the coupling shaft portion), and the like.

### DESCRIPTION OF PREFERRED EMBODIMENTS

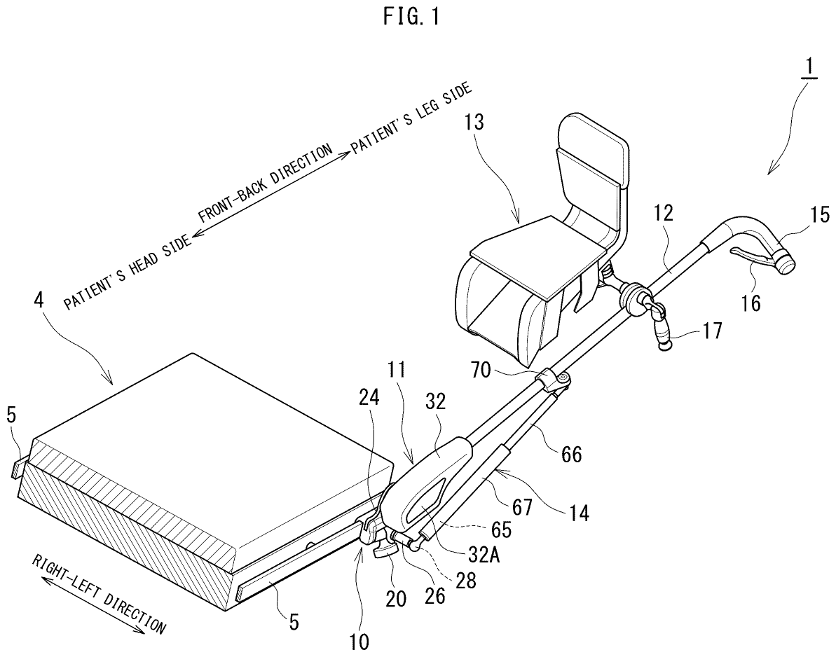

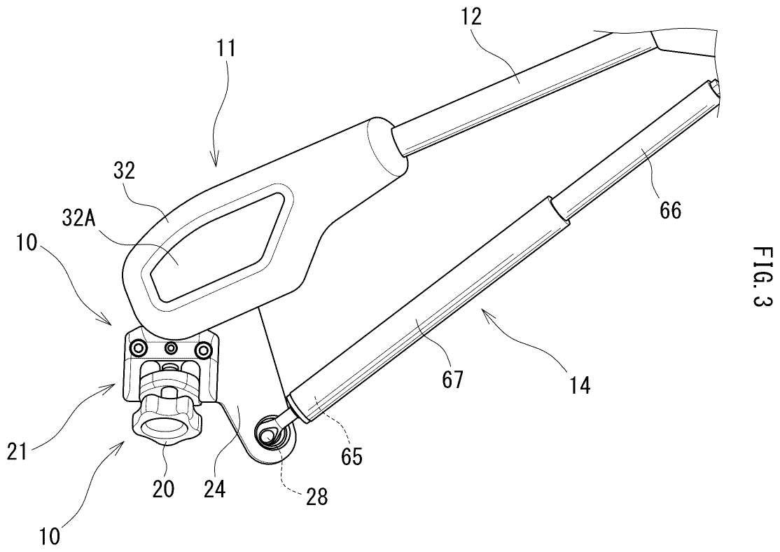

The following describes embodiments of the present invention in detail based on FIG. 1 to FIG. 13.

With reference to FIG. 1, limb support tools 1, 1 according to the embodiment support the lower limb of a patient and are provided in a left and right pair. In FIG. 1, only one limb support tool 1 is illustrated. In the following description, a width direction (short-side direction) of a surgical table 4 is referred to as a right-left direction, and a longitudinal direction of the surgical table 4 is referred to as a front-back direction. The pair of limb support tools 1, 1 are detachably attached to a pair of respective guide rails 5, 5 provided on both side surfaces in the right-left direction of the surgical table 4. The guide rail 5 extends along the front-back direction at an interval from a side surface of the surgical table 4. The guide rail 5 is formed in a rectangular cross-section shape. The limb support tool 1 according to the embodiment roughly includes an anchoring bracket 10 for attaching the limb support tool 1 to the guide rail 5 of the surgical table 4, turning restraint means 11 coupled to the anchoring bracket 10, an arm member 12 extending from the turning restraint means 11, a boot 13 slidably supported along a longitudinal direction of the arm member 12, and a gas cylinder 14. The gas cylinder 14 has one end portion in a longitudinal direction turnably coupled to the arm member 12 and another end portion in the longitudinal direction turnably supported near a base of the arm member 12.

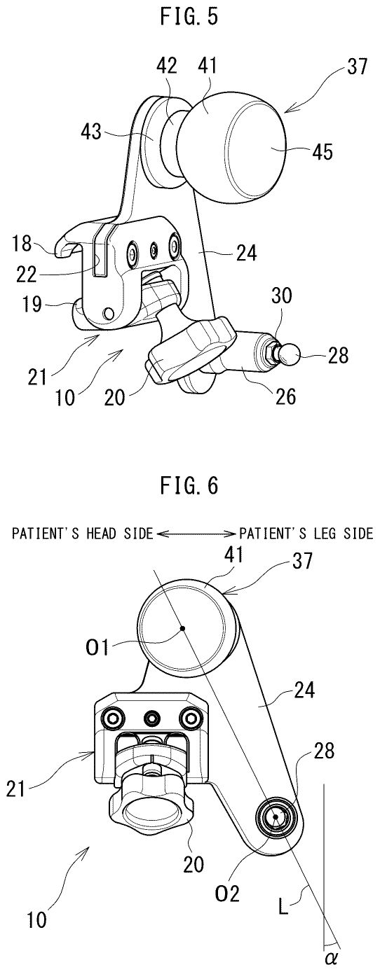

With reference to FIG. 1 to FIG. 3, FIG. 5, and FIG. 6, the anchoring bracket 10 includes a clamp main body 21 having a U-shape in front view and a fixation knob portion 20. The clamp main body 21 has a pair of upper and lower clamp portions 18, 19 that clamp the guide rail 5 from an up-down direction. In the clamp main body 21, the lower clamp portion 19 is supported in a manner that allows it to freely advance and retract relative to the upper clamp portion 18. The fixation knob portion 20 moves the lower clamp portion 19 of the clamp main body 21 toward the upper clamp portion 18. Then, the pair of upper and lower clamp portions 18, 19 of the anchoring bracket 10 (clamp main body 21) are arranged on the guide rail 5 of the surgical table 4 so as to sandwich the guide rail 5 from the up-down direction. Subsequently, by rotating the fixation knob portion 20 of the anchoring bracket 10 in a forward direction to cause the lower clamp portion 19 to press the guide rail 5, the anchoring bracket 10 (the pair of upper and lower clamp portions 18, 19) is firmly fixed to the guide rail 5. Thus, by rotating the fixation knob portion 20 of the anchoring bracket 10 in any one of the forward or reverse directions to advance and retract the lower clamp portion 19 relative to the upper clamp portion 18, the anchoring bracket 10, and eventually the limb support tool 1, can be attached to and detached from the guide rail 5 of the surgical table 4.

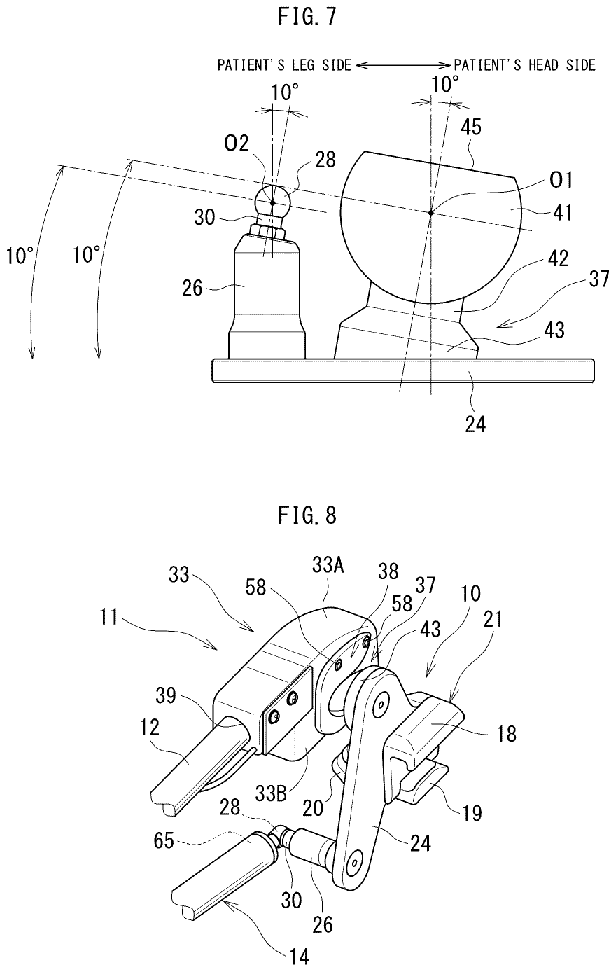

A base plate 24 is fixed to the anchoring bracket 10. The base plate 24 is disposed upright and arranged to be approximately parallel to the guide rail 5 of the surgical table 4, that is, to the front-back direction of the surgical table 4. The base plate 24 is fixed so as to be sandwiched by a recessed shape portion 22 recessed from an upper surface of the upper clamp portion 18 of the anchoring bracket 10. A spherical joint 37 of the turning restraint means 11, which will be described in detail later, is fixed at an upper portion of the base plate 24, that is, at a position above the anchoring bracket 10. Meanwhile, a coupling shaft portion 26 is fixed at a lower portion of the base plate 24, that is, at a position below the anchoring bracket 10. The coupling shaft portion 26 extends outward in the right-left direction of the surgical table 4. Additionally, with reference to FIG. 7, the coupling shaft portion 26 extends in a direction perpendicular to a surface of the base plate 24. At a distal end of the coupling shaft portion 26, a spherical portion 28 is integrally disposed via a rod portion 30. The other end portion in the longitudinal direction of the gas cylinder 14, which will be described in detail later, is mutually turnably coupled to this spherical portion 28. The rod portion 30 including the spherical portion 28 is disposed to be inclined at a predetermined inclination angle, for example, an inclination angle of approximately 10°, to a patient's head side relative to a direction perpendicular to the surface of the base plate 24.

With reference to FIG. 1, the arm member 12 is configured as an elongated cylindrical shape. The arm member 12 is made of stainless steel. An arm handle 15 that is gripped by surgical staff including an operator is disposed at a distal end part of the arm member 12. The arm handle 15 is bent slightly toward a lower side (extending downward, for example, at an inclination angle of approximately 15° relative to a horizontal direction) on an outer side in the right-left direction of the surgical table 4. A lever 16 that is operated by the surgical staff including an operator is disposed below the arm handle 15. The boot 13 is slidably supported on the arm member 12 along the longitudinal direction in a range between a bracket 70 described in detail below and the arm handle 15. The boot 13 can be restrained at any position between the bracket 70 and the arm handle 15. The boot 13 can be restrained and released from the restraint at any position along the longitudinal direction of the arm member 12 by operating a boot handle 17. The boot 13 allows for immobilization of the patient from near the knee to the tip of the foot. Then, the arm member 12 can support the lower limb of the patient. The base of the arm member 12 is supported by the turning restraint means 11.

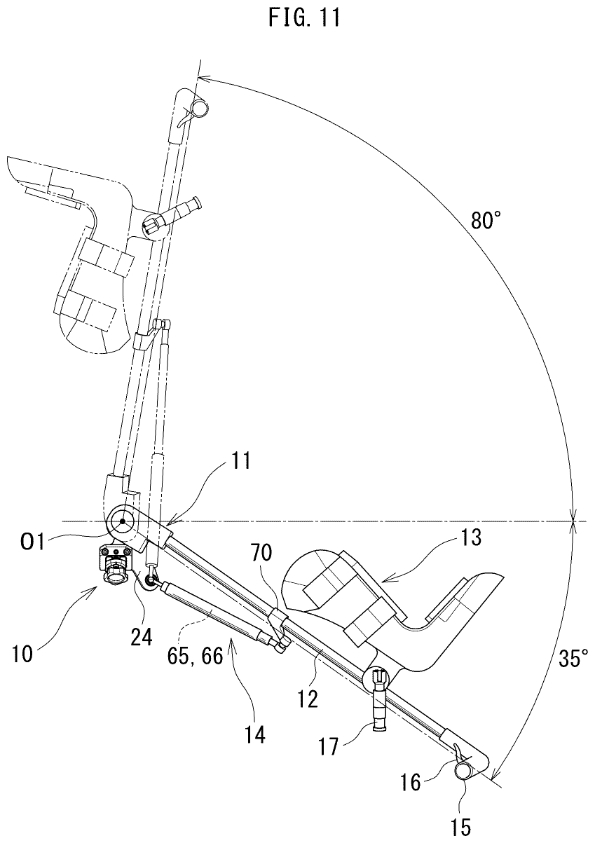

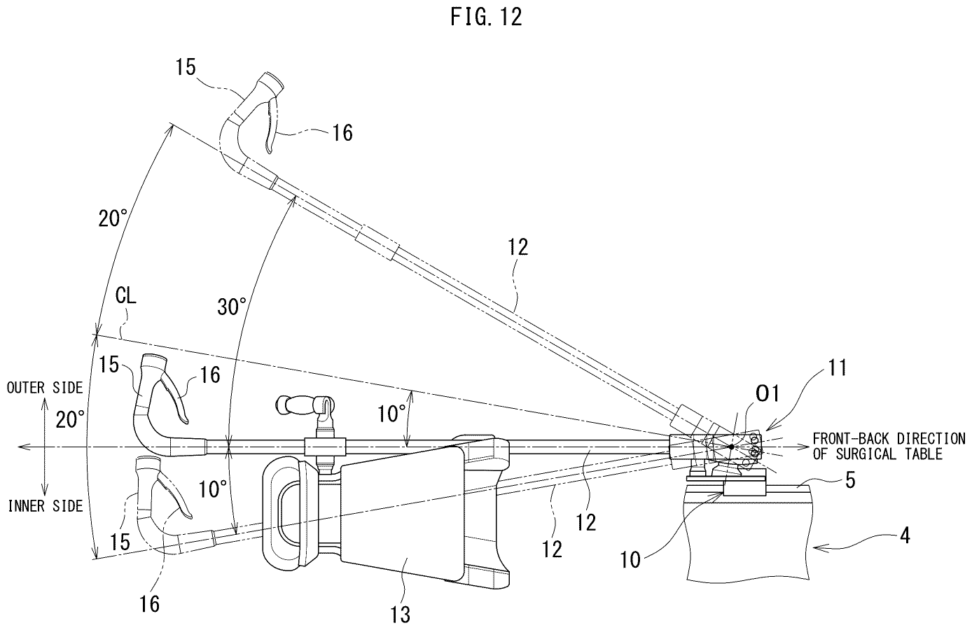

With reference to FIG. 1 to FIG. 3, FIG. 11, and FIG. 12, the turning restraint means 11 supports the arm member 12 turnably in any direction centered on the base of the arm member 12 (specifically, a center O1 of a spherical portion 41 of the spherical joint 37 described later (see FIG. 6, FIG. 7, FIG. 11, and FIG. 12)) and in a restrainable manner at any position. Also, the turning restraint means 11 restricts a turning movement of the arm member 12 around an axis center. In addition, the turning restraint means 11 restricts a turning range along the horizontal direction of the arm member 12 centered on the base of the arm member 12 (specifically, the center O1 of the spherical portion 41 of the spherical joint 37 described later (see FIG. 6, FIG. 7, FIG. 11, and FIG. 12)). Furthermore, the turning restraint means 11 supports the arm member 12 turnably along the horizontal direction relative to the front-back direction of the surgical table 4, within a range of an identical angle, for example, approximately 20°, each to an inner side and an outer side of the surgical table 4 centered on a reference line CL. The reference line CL is inclined at a predetermined inclination angle, for example, an inclination angle of 10°, to the outer side in the right-left direction of the surgical table 4 toward the patient's leg.

Specifically, with reference to FIG. 8 to FIG. 10, the turning restraint means 11 includes a body member 33 to which the base of the arm member 12 is fixed, the spherical joint 37, and a guiding member 38. The body member 33 has a spherical internal space 35 with a scalable volume. The spherical joint 37 has the spherical portion 41 arranged in the internal space 35 of the body member 33 and a neck portion 42 integrally extending from the spherical portion 41. The guiding member 38 is arranged to be brought into contact with a side surface of the body member 33 and to be brought into contact with an outer peripheral surface of the neck portion 42 extending outward from the body member 33.

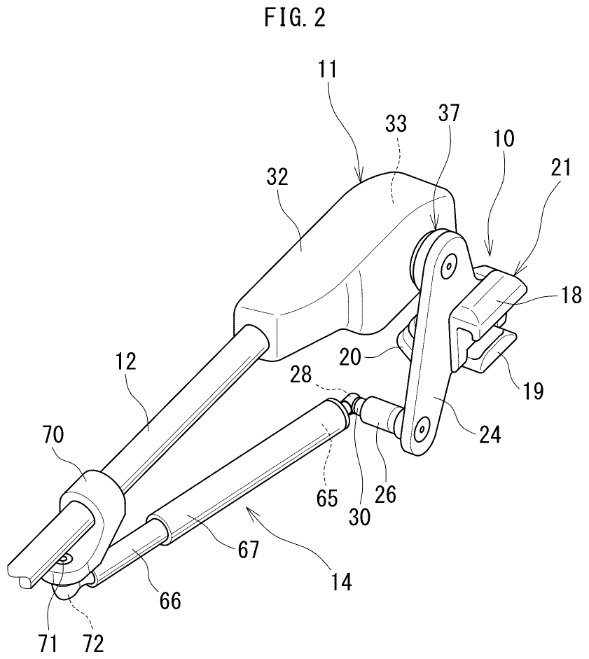

The body member 33 is divided into a pair of upper and lower parts and constituted of an upper split body member 33A and a lower split body member 33B. With reference to FIG. 1 and FIG. 2, the body member 33 is covered by a cover member 32. The cover member 32 is made of an easily bendable soft synthetic resin with low rigidity. A reference numeral 32A is a cover lid member. The upper split body member 33A and the lower split body member 33B are made of aluminum alloy. With reference to FIG. 8 to FIG. 10, an insertion hole 39 is drilled into the upper split body member 33A from a front face of the upper split body member 33A along an axial direction of the arm member 12. The base of the arm member 12 is inserted and fixed into the insertion hole 39 of the upper split body member 33A. The upper split body member 33A is configured to have a longer length along the axial direction of the arm member 12 than the lower split body member 33B. In other words, the upper split body member 33A is configured so that it is disposed to protrude to the arm member 12 side with respect to the lower split body member 33B. A housing recess 34A is formed in the upper split body member 33A. The housing recess 34A is recessed from a lower surface and open at both side surfaces in a semicircular shape to penetrate in the right-left direction. An inner wall portion of the housing recess 34A is formed on a spherical surface.

A housing recess 34B is also formed in the lower split body member 33B so as to be opposed to the housing recess 34A of the upper split body member 33A. The housing recess 34B is formed to be recessed from an upper surface and open at both side surfaces in a semicircular shape to penetrate in the right-left direction. An inner wall portion of the housing recess 34B is also formed on a spherical surface. A portion on the arm member 12 side of the lower split body member 33B is supported in a manner that allows it to freely advance and retract relative to the upper split body member 33A. The portion on the arm member 12 side of the lower split body member 33B advances to the upper split body member 33A side, thereby decreasing the volume of the spherical internal space 35, into which the housing recess 34A of the upper split body member 33A and the housing recess 34B of the lower split body member 33B are combined. On the other hand, the portion on the arm member 12 side of the lower split body member 33B retracts to an initial position, thereby expanding the volume of the spherical internal space 35, into which the housing recess 34A of the upper split body member 33A and the housing recess 34B of the lower split body member 33B are combined.

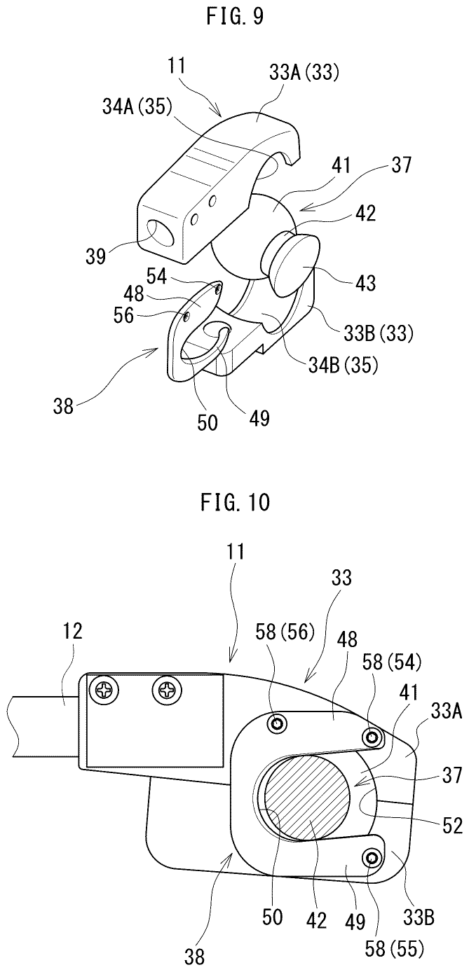

With reference to FIG. 8 to FIG. 9, the spherical joint 37 includes the spherical portion 41, the column-shaped neck portion 42 integrally extending from the spherical portion 41, and a mounting flange portion 43 integrally extending from the neck portion 42. The spherical joint 37 is made of aluminum alloy. In the spherical portion 41, a planar end surface 45 (see FIG. 5) is formed on the opposite side of the neck portion 42. The spherical portion 41 is arranged in the spherical internal space 35, into which the housing recess 34A of the upper split body member 33A and the housing recess 34B of the lower split body member 33B are combined. The neck portion 42 extends outward from the respective housing recesses 34A, 34B (internal space 35) of the upper and lower split body members 33A, 33B toward the base plate 24. The mounting flange portion 43 is fixed to the upper portion of the base plate 24.

With reference to FIG. 7, the mounting flange portion 43 has a thickness that differs along the front-back direction of the surgical table 4. Specifically, the mounting flange portion 43 is formed to be thicker toward the patient's leg side in the front-back direction of the surgical table 4. As a result, the spherical portion 41 and the neck portion 42 of the spherical joint 37 are placed to be inclined at a predetermined inclination angle, for example, an inclination angle of approximately 10°, to the patient's head side relative to the direction perpendicular to the surface of the base plate 24. As described above, with reference to FIG. 7, the rod portion 30 including the spherical portion 28 is also disposed to be inclined at a predetermined inclination angle, for example, an inclination angle of approximately 10°, to the patient's head side relative to the direction perpendicular to the surface of the base plate 24, similarly to the spherical portion 41 and the neck portion 42 of the spherical joint 37. The other end portion in the longitudinal direction of the gas cylinder 14 is turnably coupled to the spherical portion 28.

Then, although the description of the detailed structure is omitted, when the lever 16 of the arm handle 15 at the distal end of the arm member 12 illustrated in FIG. 1 is pulled, with reference to FIG. 8 and FIG. 9, the portion on the arm member 12 side of the lower split body member 33B retracts to the initial position. The internal space 35, into which a housing recess 34A of the upper split body member 33A and a housing recess 34B of the lower split body member 33B are combined, expands, and a clearance is generated between the spherical surfaces of the respective housing recesses 34A, 34B of the upper and lower split body members 33A, 33B and the spherical portion 41 of the spherical joint 37. As a result, the upper and lower split body members 33A, 33B can move relative to the spherical portion 41 of the spherical joint 37. The arm member 12, together with the upper and lower split body members 33A, 33B, becomes turnable in any direction with the center O1 (see FIG. 6, FIG. 7, FIG. 11, and FIG. 12) of the spherical portion 41 of the spherical joint 37 as the supporting point.

On the other hand, when the restraint position of the arm member 12 is determined, with reference to FIG. 8 and FIG. 9, the portion on the arm member 12 side of the lower split body member 33B advances toward the upper split body member 33A by releasing the operation of pulling the lever 16 illustrated in FIG. 1. The internal space 35, into which the housing recess 34A of the upper split body member 33A and the housing recess 34B of the lower split body member 33B are combined, shrinks, and the spherical surfaces of the respective housing recesses 34A, 34B of the upper and lower split body members 33A, 33B and the spherical portion 41 of the spherical joint 37 are firmly pressed against one another. As a result, the relative movement of the upper and lower split body members 33A, 33B relative to the spherical portion 41 of the spherical joint 37 is restricted, that is, the turning movement of the arm member 12 is restricted, and the arm member 12 is restrained to a desired position.

With reference to FIG. 8 to FIG. 10, the guiding member 38 is formed in a plate shape having a predetermined thickness. The guiding member 38 is made of brass. The guiding member 38 is formed in a U-shape having an upper wall portion 48 and a lower wall portion 49. The distance between the upper wall portion 48 and the lower wall portion 49 of the guiding member 38 is approximately equal to an outer diameter of the neck portion 42 of the spherical joint 37. The guiding member 38 is fitted with the outer periphery of the neck portion 42 of the spherical joint 37 from its open side along the horizontal direction in an upright state. As a result, opposed wall surfaces of the upper wall portion 48 and the lower wall portion 49 of the guiding member 38, which are opposed to one another, are each brought into contact with the outer peripheral surface of the neck portion 42. The guiding member 38 is brought into contact with the side surfaces of the upper and lower split body members 33A, 33B and fixed at three points.

That is, with reference to FIG. 10, respective mounting bolts 58, 58 are inserted into mounting holes 54, 55 disposed in respective distal end portions of the upper wall portion 48 and the lower wall portion 49 of the guiding member 38. Then, the mounting bolts 58, 58 are fixed to the respective side surfaces of the upper and lower split body members 33A, 33B. In addition, a mounting bolt 58 is inserted into a mounting hole 56 disposed in a base end portion of the upper wall portion 48 of the guiding member 38 and fixed to the upper split body member 33A. The fixing positions of the guiding member 38 with the upper and lower split body members 33A, 33B must be set in such positions as described above that advancing and retracting of the lower split body member 33B (the portion on the arm member 12 side) relative to the upper split body member 33A cannot be hindered. The guiding member 38 is brought into contact with the side surfaces of the upper and lower split body members 33A, 33B and fixed, and the upper wall portion 48 and the lower wall portion 49 are brought into contact with the outer peripheral surface of the neck portion 42 of the spherical joint 37. Therefore, the rotation of the arm member 12, including the upper and lower split body members 33A, 33B, around the axis center is restricted. A surface exposed to the outside of the guiding member 38, that is, a surface opposite to mounting surfaces of the upper and lower split body members 33A, 33B, is formed into a gradual convex surface.

In addition, with reference to FIG. 5 to FIG. 7, FIG. 10, and FIG. 12, the turning movement of the arm member 12 to the outer side of the surgical table 4 along the horizontal direction, with the base of the arm member 12, specifically, the center O1 of the spherical portion 41 of the spherical joint 37, as the supporting point, is restricted by the interference of a semicircular opening edge portion 52 with the neck portion 42 of the spherical joint 37. The opening edge portion 52 is disposed on the side surfaces of the upper and lower split body members 33A, 33B, specifically, near the distal ends of the upper wall portion 48 and the lower wall portion 49 of the guiding member 38. On the other hand, the turning movement of the arm member 12 to the inner side of the surgical table 4 along the horizontal direction, with the base of the arm member 12, specifically, the center O1 of the spherical portion 41 of the spherical joint 37, as the supporting point, is restricted by the interference of a bottom portion 50 with the neck portion 42 of the spherical joint 37. The bottom portion 50 lies between the upper wall portion 48 and the lower wall portion 49 of the guiding member 38.

Then, with reference to FIG. 12, the arm member 12 is turned along the horizontal direction relative to the front-back direction of the surgical table 4, within a range of an identical angle, for example, approximately 20°, each to the inner side and the outer side of the surgical table 4 centered on the reference line CL. The reference line CL is inclined at a predetermined inclination angle, for example, an inclination angle of approximately 10°, to the outer side in the right-left direction of the surgical table 4 toward the patient's leg. As a result, the arm member 12 becomes turnable along the horizontal direction, centered on the base of the arm member 12 (specifically, the center O1 of the spherical portion 41 of the spherical joint 37), relative to the front-back direction of the surgical table 4, for example, up to a maximum turning angle of approximately 30° to the outer side in the right-left direction of the surgical table 4 and up to a maximum turning angle of approximately 10° to the inner side in the right-left direction of the surgical table 4.

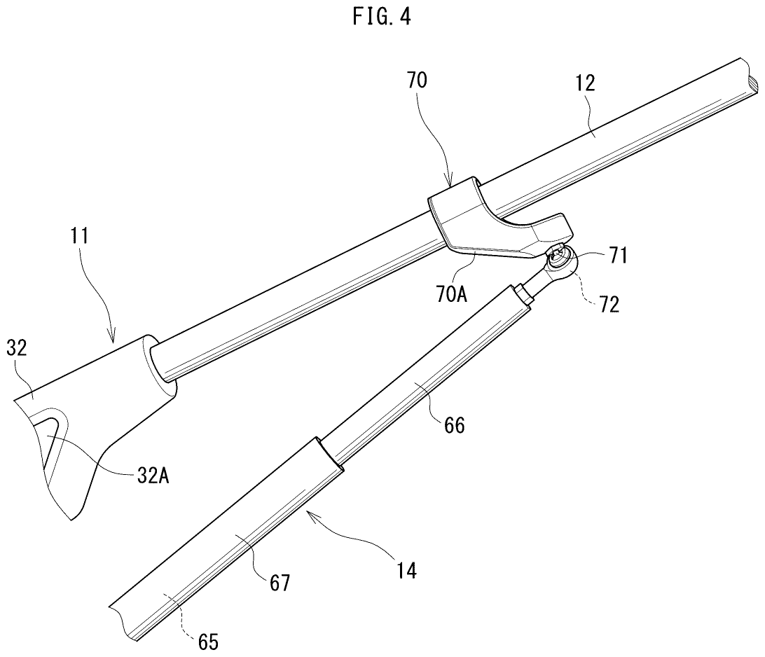

With reference to FIG. 1 to FIG. 4, the gas cylinder 14 includes a cylinder portion 66 with internal air pressure and a telescopic piston rod 65 from the cylinder portion 66. The gas cylinder 14 has a cylinder cover 67 that covers an approximately entire area in a length direction of the cylinder portion 66 when the piston rod 65 is in the most shrunk state and covers an approximately entire area in a length direction of the piston rod 65 when the piston rod 65 is in the most extended state. The gas cylinder 14 has a function to support, in particular, a lifting/lowering operation (turning operation along the up-down direction with the center O1 of the spherical portion 41 of the spherical joint 37 as the supporting point (see FIG. 6 and FIG. 11)) of the arm member 12. One end portion in the longitudinal direction of the gas cylinder 14 is turnably coupled to the arm member 12, and the other end portion in the longitudinal direction of the gas cylinder 14 is turnably supported so as to be able to turn in any direction together with the arm member 12. With reference to FIG. 1, FIG. 2, and FIG. 4, the bracket 70 is fixed to the arm member 12 at a position slightly toward the turning restraint means 11 side from an approximately intermediate position in the longitudinal direction of the arm member 12. The bracket 70 is formed in an approximate L-shape in side view, which extends downward from the fixing position with the arm member 12 and extends through a bend portion 70A toward the distal end of the arm member 12. The bend portion 70A has an outer corner portion cut out in a planar shape.

With reference to FIG. 2 and FIG. 4, a coupling shaft portion 71 extends downward at a distal end of the bracket 70. A spherical portion 72 is disposed at a distal end of the coupling shaft portion 71. One end portion in the longitudinal direction of the gas cylinder 14, specifically, a base end portion of the cylinder portion 66, is mutually turnably coupled to the spherical portion 72 of the coupling shaft portion 71. Meanwhile, the other end portion in the longitudinal direction of the gas cylinder 14, specifically, a distal end portion of the piston rod 65, is mutually turnably coupled to the spherical portion 28 (see FIG. 5 and FIG. 6) of the coupling shaft portion 26. The coupling shaft portion 26 extends toward the outer side in the right-left direction of the surgical table 4 from the lower portion of the base plate 24. With reference to FIG. 1, FIG. 2, and FIG. 6, in a state where the limb support tool 1 according to the embodiment is attached to the guide rail 5 of the surgical table 4 via the anchoring bracket 10, a turning center at the other end portion in the longitudinal direction of the gas cylinder 14, that is, the center O2 of the spherical portion 28 of the coupling shaft portion 26, is positioned below a turning center at the base of the arm member 12, that is, the center O1 of the spherical portion 41 of the spherical joint 37 and on the patient's leg side. In addition, a straight line L connecting the turning center at the other end portion in the longitudinal direction of the gas cylinder 14 (the center O2 of the spherical portion 28 of the coupling shaft portion 26) and the turning center at the base of the arm member 12 (the center O1 of the spherical portion 41 of the spherical joint 37) is set with an inclination angle α relative to a vertical direction within a range between 15° and 30°. The inclination angle α is preferably set within a range between 20° and 25°. In the embodiment, the inclination angle α is set to about 22°.

With reference to FIG. 11, the limb support tool 1 according to the embodiment does not employ a stopper structure to restrict an upper limit position and a lower limit position of the arm member 12. The upper limit position of the arm member 12 is restricted when the piston rod 65 of the gas cylinder 14 is in the most extended state, while the lower limit position of the arm member 12 is restricted when the piston rod 65 of the gas cylinder 14 is in the most shrunk state. For the upper limit position of the arm member 12, an upward turning angle relative to the horizontal direction is set to, for example, approximately 80° with the turning center at the base of the arm member 12 (the center O1 of the spherical portion 41 of the spherical joint 37) as the supporting point. On the other hand, for the lower limit position of the arm member 12, a downward turning angle relative to the horizontal direction is set to, for example, approximately 35°.

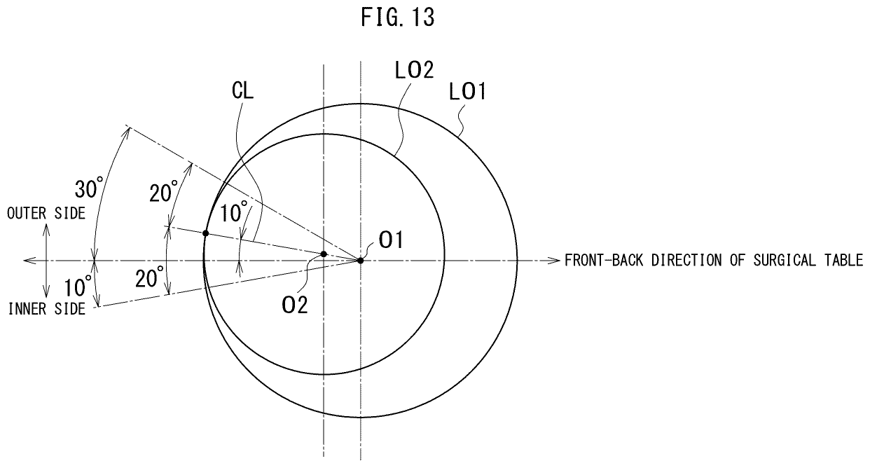

With reference to FIG. 7 and FIG. 13, the center O2 of the spherical portion 28 of the coupling shaft portion 26 to which the other end portion in the longitudinal direction of the gas cylinder 14 is turnably coupled is slightly different in position from the center O1 of the spherical portion 41 of the spherical joint 37 in the front-back direction of the surgical table 4. The spherical portion 41 is arranged in the respective housing recesses 34A, 34B (see FIG. 9) of the upper and lower split body members 33A, 33B. Therefore, a difference occurs between a turning trajectory LO1 along the horizontal direction relative to the turning center of the arm member 12 (the center O1 of the spherical portion 41 of the spherical joint 37) at any position in the longitudinal direction of the arm member 12 and a turning trajectory LO2 along the horizontal direction relative to the turning center of the gas cylinder 14 (the center O2 of the spherical portion 28 of the coupling shaft portion 26) at any position in the longitudinal direction of the arm member 12.

That is, the distance between any position in the longitudinal direction of the arm member 12 and the turning center O1 of the arm member 12 is greater than the distance between any position in the longitudinal direction of the arm member 12 and the turning center O2 of the gas cylinder 14 in the front-back direction of the surgical table 4. Therefore, as the turning angle along the horizontal direction of the arm member 12 gradually increases, a state where the piston rod 65 gradually extends from the cylinder portion 66 of the gas cylinder 14 occurs. In short, the turning angle along the horizontal direction of the arm member 12 greatly varies the amount of extension of the piston rod 65 from the cylinder portion 66 of the gas cylinder 14. As a result, the lower limit position of the arm member 12 greatly varies depending on the turning angle along the horizontal direction of the arm member 12.

In order to suppress this, with reference to FIG. 12 and FIG. 13, in the limb support tool 1 according to the embodiment, as described above, with the configuration of the turning restraint means 11, the arm member 12 is turned along the horizontal direction relative to the front-back direction of the surgical table 4, within a range of an identical angle, for example, approximately 20°, each to the inner side and the outer side of the surgical table 4 centered on the reference line CL. The reference line CL is inclined at a predetermined inclination angle, for example, an inclination angle of approximately 10°, to the outer side in the right-left direction of the surgical table 4 toward the patient's leg. As a result, the amount of extension of the piston rod 65 from the cylinder portion 66 of the gas cylinder 14 depending on the turning angle along the horizontal direction of the arm member 12 described above can be made minute within the turning range along the horizontal direction of the arm member 12 (for example, within the range of approximately 30° to the outer side and approximately 10° to the inner side in the right-left direction of the surgical table 4). Accordingly, a large variation in the lower limit position of the arm member 12 depending on the turning angle along the horizontal direction of the arm member 12 can be suppressed.

With the limb support tool 1 according to the embodiment described above, the upper limit position of the arm member 12 is restricted when the piston rod 65 of the gas cylinder 14 is in the most extended state, while the lower limit position of the arm member 12 is restricted when the piston rod 65 of the gas cylinder 14 is in the most shrunk state. As a result, it is possible to ensure the turning range along the desired up-down direction without the need for a proximal gas piston mounting element turnably coupled to a limb holder support structure mounting element corresponding to the base plate 24, compared to the prior art (invention of Patent Document 1) described above. The limb support tool 1 according to the embodiment can simplify the structure, reduce the number of parts, and eventually reduce the manufacturing cost. In addition, the limb support tool 1 according to the embodiment employs a stopper structure for the restriction of the turning range along the horizontal direction of the arm member 12, but it does not employ any stopper structure for the restriction of the turning range along the up-down direction. Therefore, defects such as damage to members interfering with one another can be kept to a minimum, and reliability can be improved.

Further, according to the limb support tool 1 according to the embodiment, the other end portion in the longitudinal direction of the gas cylinder 14 is turnably supported directly on the spherical portion 28 of the coupling shaft portion 26 disposed to protrude from the surface of the base plate 24 fixed to the surgical table 4. This eliminates the need for the proximal gas piston mounting element turnably coupled to the limb holder support structure mounting element corresponding to the base plate 24, as it is needed in the prior art (invention of Patent Document 1) described above. Therefore, from this point as well, the limb support tool 1 according to the embodiment allows simplifying the structure and reducing the number of parts.

Furthermore, according to the limb support tool 1 according to the embodiment, in a state where the limb support tool 1 is attached to the guide rail 5 of the surgical table 4 via the anchoring bracket 10, the turning center at the other end portion in the longitudinal direction of the gas cylinder 14 (the center O2 of the spherical portion 28 of the coupling shaft portion 26) is positioned below the turning center at the base of the arm member 12 (the center O1 of the spherical portion 41 of the spherical joint 37) and on the patient's leg side. The straight line L connecting the turning center at the other end portion in the longitudinal direction of the gas cylinder 14 (the center O2 of the spherical portion 28 of the coupling shaft portion 26) and the turning center at the base of the arm member 12 (the center O1 of the spherical portion 41 of the spherical joint 37) is set with an inclination angle relative to the vertical direction within a range between 15° and 30°. Accordingly, the respective upper and lower limit positions of the arm member 12 can be restricted in a state where the piston rod 65 of the gas cylinder 14 is in the most extended and shrunk states without complicating the structure, and the desired turning range along the up-down direction can be set.

Moreover, according to the limb support tool 1 according to the embodiment, the spherical portion 28 of the coupling shaft portion 26 disposed to protrude from the surface of the base plate 24 fixed to the surgical table 4 is inclined at a predetermined inclination angle, for example, an inclination angle of 10°, to the patient's head side relative to the direction perpendicular to the surface of the base plate 24. This can increase the turning range of the gas cylinder 14 to the outer side in the right-left direction of the surgical table 4 along the horizontal direction.

Furthermore, according to the limb support tool 1 according to the embodiment, the arm member 12 is turnably supported along the horizontal direction relative to the front-back direction of the surgical table 4, within a range of an identical angle, for example, 20°, each to the inner side and the outer side of the surgical table 4 centered on the reference line CL. The reference line CL is inclined to the outer side in the right-left direction of the surgical table 4 toward the patient's leg. This allows the amount of extension of the piston rod 65 of the gas cylinder 14 depending on the turning angle along the horizontal direction of the arm member 12 to be minute within the turning range along the horizontal direction of the arm member 12 (within the range of approximately 30° to the outer side and approximately 10° to the inner side in the right-left direction of the surgical table 4) and eventually allows suppressing a large variation in the lower limit position of the arm member 12 depending on the turning angle along the horizontal direction of the arm member 12.

Additionally, according to the limb support tool 1 according to the embodiment, the bracket 70 that couples one end portion in the longitudinal direction of the gas cylinder 14 to the arm member 12 is formed in an approximate L-shape in side view. This can ensure the required overall length of the gas cylinder 14, that is, the length of extension and shrinkage of the piston rod 65, while ensuring a sufficient amount of sliding of the boot 13 on the arm member 12.

### DESCRIPTION OF REFERENCE SIGNS

1 Limb support tool
4 Surgical table
12 Arm member
14 Gas cylinder
24 Base plate
28 Spherical portion
65 Piston rod
70 Bracket

1. A limb support tool attached to a surgical table to support a patient's limb, the limb support tool comprising:
an arm member that supports a patient's limb, the arm member being supported turnably in any direction centered on a base thereof and in a restrainable manner at any position; and
a gas cylinder having one end portion in a longitudinal direction turnably coupled to the arm member, the gas cylinder being supported turnably in any direction together with the arm member, wherein
an upper limit position of the arm member is restricted when a piston rod of the gas cylinder is in a most extended state, while a lower limit position of the arm member is restricted when the piston rod of the gas cylinder is in a most shrunk state.

2. The limb support tool according to claim 1, wherein
another end portion in a longitudinal direction of the gas cylinder is turnably supported on a spherical portion disposed to protrude from a surface of a base plate fixed to the surgical table.

3. The limb support tool according to claim 2, wherein
a turning center at the other end portion in the longitudinal direction of the gas cylinder is positioned below a turning center at the base of the arm member and on a patient's leg side, and
a straight line connecting the turning center at the other end portion in the longitudinal direction of the gas cylinder and the turning center at the base of the arm member is set with an inclination angle relative to a vertical direction within a range between 15° and 30°.

4. The limb support tool according to claim 2, wherein
the base plate is disposed upright to be approximately parallel to a front-back direction of the surgical table, and
the spherical portion is inclined at a predetermined inclination angle to a patient's head side relative to a direction perpendicular to a surface of the base plate.

5. The limb support tool according to claim 1, wherein
the arm member is supported turnably along a horizontal direction relative to a front-back direction of the surgical table, within a range of an identical angle each to an inner side and an outer side of the surgical table centered on a reference line, the reference line being inclined to an outer side in a right-left direction of the surgical table toward a patient's leg.

6. The limb support tool according to claim 1, wherein
one end portion in a longitudinal direction of the gas cylinder is coupled to the arm member via a bracket, and
the bracket is formed in an approximate L-shape in side view.
